(19) United States
(12) Patent Application Publication
(10) Pub. No.: US 2025/0000613 A1
(43) Pub. Date: Jan. 2, 2025

(54) Dental post and dental implant

(71) Applicant: Franz Sutter, Thun (CH)

(72) Inventor: Franz Sutter, Thun (CH)

(21) Appl. No.: 18/216,620

(22) Filed: Jun. 30, 2023

(51) Int. Cl. A61C 5/35

(52) U.S. Cl. CPC A61C 5/35

(57) ABSTRACT

A dental post and dental implant with a dental post are disclosed. The dental post includes a longitudinal shaft with a cylindrical or conical outer surface, a central axis, a first end and a second end. At least one connection element is located on the second end or an abutment structure is located on the second end. A first portion extends from the first end towards the second end of the longitudinal shaft along a first defined length, the first portion includes at least one retaining structure to securely anchor the longitudinal shaft in the bore, the at least one retaining structure protruding from the outer surface by a first distance. A second portion extends from the second end towards the first portion, the second portion includes at least one circumferential protrusion having a first flank facing towards the first end.

### BACKGROUND OF THE INVENTION

### Technical Field

The invention relates to a dental post as well as a dental implant comprising a dental post, which both greatly reduce the occurrence of peri-implantitis, peri-implant mucositis and bacterial infiltration defect.

### Background Art

Dental posts are used to retain dental crowns in the case that the amount of remaining sound tooth tissue is insufficient to retain a conventional crown. Dental posts may be cemented or screwed into a prepared root canal. Usually, an abutment is subsequently secured to the end of the dental post which protrudes from the root canal, said abutment then providing a connection to a crown. Certain dental posts comprise an integrated abutment structure, i.e. the dental post and the abutment structure are a single piece, such that the dental crown may directly be attached to the abutment structure after securing the dental post in a root canal. Various different dental posts from different manufacturers are known in the art.

Dental posts as well as dental implants comprising a dental post are known in the art. For example, CH 707 433 B1 discloses a dental implant and a dental post for a dental implant. The dental post comprises a longitudinal shaft with a retaining structure in the form of a screw thread as well as several circumferential ribs which protrude further outwards from an outer surface of the longitudinal shaft than the screw thread. The circumferential ribs comprise a circumferential cusp and two flanks which span from the cusp towards an outer surface of the longitudinal shaft. The flanks are angled at different angles relative to a central axis of the longitudinal shaft and descend from the cusp towards the same end of the longitudinal shaft.

CH 696 800 A5 describes a kit of parts for forming a dental implant comprising a dental post with a longitudinal shaft. The longitudinal shaft of the dental post comprises a retaining structure in the form of a screw thread as well as several circumferential ribs which protrude further outwards from an outer surface of the longitudinal shaft than the screw thread. The circumferential ribs comprise a circumferential cusp and two flanks which span from the cusp towards an outer surface of the longitudinal shaft. While one flank descends from the cusp towards one end of the longitudinal shaft, the other flank is substantially orthogonal relative to the central axis of the longitudinal shaft.

While dental posts provide a secure attachment for dental crowns at locations where a conventional crown may not be used due to the state of the surrounding tooth tissue, certain health issues may be caused by dental posts. Notably, peri-implantitis is a destructive inflammatory process affecting the soft and hard tissues surrounding dental post. Thereby, the soft tissues around the dental post become inflamed while the alveolar bone surrounding the dental post degrades. This loss of bone tissue around the dental post affects the safe anchoring of the dental post over time. Treatment of peri-implantitis is challenging, unpredictive and expensive. The treatment can vary considerably from patient to patient, and may include non-surgical therapy, with the aim of controlling the infection and to detoxify the dental post surface, as well as surgical procedures to regenerate the alveolar bone tissue lost.

Another issue is peri-implant mucositis, which is an inflammatory lesion of the peri-implant mucosa in the absence of alveolar bone loss. Peri-implant mucositis is usually caused by the accumulation of bacteria around the Osseo integrated dental post, often leading to the formation of a biofilm around the dental post. Peri-implant mucositis may be treated by regular cleaning of the area both by patients and dental professionals.

Infiltration of bacteria and subsequent formation of a biofilm around a dental post may lead to surface damage of the dental post, resulting in in vivo release of metallic particles, leading to bacterial infiltration defects of the dental post.

As various studies reveal, peri-implantitis and bone resorption may also be caused or promoted by mechanical forces acting on the dental implant, thereby leading to an overloading of the alveolar bone surrounding the dental post. These mechanical forces especially arise during masticatory movement

### BRIEF SUMMARY OF THE INVENTION

It is therefore the object of the present invention to create a dental post which prevents the infiltration of bacteria and which avoids the occurrence of high forces on the alveolar bone, especially during masticatory movement.

According to the invention the dental post comprises a longitudinal shaft to be inserted into a bore in a root canal, the shaft comprising a cylindrical or conical outer surface, a central axis, a first end and a second end. At least one connection element is located on the second end. Alternatively, an abutment structure is located on the second end. A first portion extends from the first end towards the second end along a first defined length. The first portion comprises at least one retaining structure to securely anchor the shaft in the bore. The at least one retaining structure protrudes from the outer surface by a first distance. A second portion extends from the second end towards the first portion. The second portion comprises at least one circumferential protrusion having a first flank facing towards the first end and extending from the outer surface to a cusp located at a second distance from the outer surface. The second distance is larger than the first distance. The at least one protrusion includes a second flank facing towards the second end and extending from the cusp to the outer surface. The second flank is substantially flat from the cusp towards the outer surface and is inclined at a first angle of from 20° to 50°, preferably of from 25° to 40° relative to the central axis in a radial plane including the central axis.

The second flank allows to dissipate the forces acting on the dental post after masticatory unloading into the surrounding alveolar bone tissue in a direction which is parallel to the central axis of the dental post, but directed away of the dental post. Even after unloading of an overloaded masticatory pressure, no residual tension remains in the surrounding alveolar bone thanks to the force dissipation caused by the second flank. This prevents the disconnection of the surface of the dental post with the surrounding alveolar bone tissue and thereby greatly reduces the occurrence of peri-implantitis and peri-mucositis, as no interstice forms between the surface of the dental post and the alveolar bone tissue in reaction to the force unloading.

The longitudinal shaft of the dental post is preferably made of a metal or alloy, preferably of titanium or a titanium alloy as known in the art. Alternatively, the longitudinal shaft may also be made of a composite material, such as a glass-fiber composite material, or ceramic material. The longitudinal shaft may be of any suitable length and have any suitable diameter.

The central axis of the longitudinal shaft is the geometrical central axis, i.e. the axis spanning in the center of the longitudinal shaft.

The radial plane including the central axis is an imaginary plane which is parallel to and includes the central axis, i.e. the central axis spans within the radial plane. Further, the radial plane is arranged on a radius of the longitudinal shaft. In other words, the central axis as well as a radius of the longitudinal shaft are vectors which span the radial plane. As the longitudinal shaft is cylindrical or conical and hence comprises a circular cross section, there are a multitude of radial planes which are spanned by the central axis and a radius of the longitudinal shaft. In this context, when the radial plane including the central axis is mentioned in the present application, this means that only one of said multitude of radial planes is meant. However, as the at least one protrusion is formed to be identical around the entire circumference of the longitudinal shaft, it is irrelevant which radius is used to span the radial plane, as a cross section of the at least one protrusion looks the same at any angular position around the circumference of the longitudinal shaft.

The first end is the end of the longitudinal shaft which is introduced into the bore of the root canal. The second end of the longitudinal axis is the end which protrudes out of the bore of the root canal when the dental post is inserted therein.

In a preferred embodiment, the second end of the longitudinal shaft comprises a connection element. This connection element serves to connect an abutment to the longitudinal shaft once the longitudinal shaft is implanted in a bore of a root canal.

In an alternatively preferred embodiment, the second end of the longitudinal shaft comprises an abutment structure. This abutment structure serves to connect a dental crown on the longitudinal shaft once the longitudinal shaft is implanted in a bore of a root canal.

The defined length of the first portion preferably is at least 50% of the length of the longitudinal shaft from the first end to the second end in the direction of the central axis, more preferably at least 60%, most preferably at least 70% of the length of the longitudinal shaft from the first end to the second end in the direction of the central axis.

The at least one retaining structure protrudes from the outer surface of the longitudinal shaft by a first distance, thereby allowing a form fit connection between the longitudinal shaft and surrounding alveolar bone tissue when the longitudinal shaft is inserted in a bore of a root canal, thereby securely anchoring the longitudinal shaft in the root canal. The at least one retaining structure may be of any suitable type, e.g. a thread as known in the art.

Prior to the insertion of the longitudinal shaft into the root canal, the root canal is preferably prepared by widening the root canal by means of a drill, such as to provide a bore with a suitable diameter, a sufficient length and defined shape. The longitudinal shaft may subsequently be inserted or screwed into the prepared bore of the root canal. In addition to the retaining structure, the longitudinal shaft may additionally be anchored within the root canal by addition of bone cement.

The second portion extends from the second end towards the first portion in the direction of the central axis. Preferably, the longitudinal shaft only comprises the first portion and the second portion, i.e. the first portion extends from the first end for the first defined length to an end point and the second portion extends from the end point of the first portion to the second end along a second defined length. The sum of the first defined length and of the second defined length thereby corresponds to the length of the longitudinal shaft along the central axis. In further embodiments, however, the longitudinal shaft may comprises additional portions between the first and the second portion, e.g. such as a third portion.

The at least one circumferential protrusion spans the entire circumference of the longitudinal shaft, i.e. the at least one circumferential protrusion extends around 360° of the longitudinal shaft. The first flank defines a first side surface of the protrusion and extends from the outer surface of the longitudinal shaft to a cusp of the at least one protrusion. The cusp forms the outermost circumference of the at least one circumferential protrusion, which is spaced apart from the outer surface of the longitudinal shaft by the second distance. The second distance thereby is larger than the first distance, i.e. the cusp is spaced further away of the outer surface than the at least one retaining structure.

The second flank extends between the cusp of the at least one protrusion back towards the outer surface of the longitudinal shaft and thereby forms a second side surface of the at least one protrusion. The second flank is substantially flat, i.e. the second flank, when viewed in a cross section of the at least one protrusion in the radial plane including the central axis, follows a substantially straight line. The term substantially flat means that the second flank is flat but may have of an area where the second flank transitions to the outer surface of the longitudinal shaft which comprises a curvature, such as to provide a smooth transition between the second flank and the outer surface.

The second flank is inclined at the first angle of from 20° to 50°, preferably of from 25° to 40° relative to the central axis in a radial plane including the central axis, i.e. the second flank is angled relative to the central axis by the first angle. Hence, the at least one protrusion comprises a second side surface having the shape of a cone frustum. The first angle thereby corresponds to the half angle of the cone frustum of the second side surface.

The second flank ascends from the cusp towards the outer surface of the longitudinal shaft in the direction towards the second end. This means that any point on the second flank lies closer to the second end than the cusp. Contrary thereto the first flank descends from the cusp towards the outer surface of the longitudinal shaft towards the first end. This means that any point on the first flank lies closer to the first end than the cusp.

The inclination of the second flank allows to direct forces acting on the longitudinal shaft parallel to the central axis and in an oblique direction towards the second end and away of the longitudinal shaft at an angle of from 20° to 50°, preferably of from 25° to 40° into the surrounding alveolar bone tissue once the dental post is implanted. Further, as the at least one protrusion is spaced further away of the outer surface of the longitudinal shaft than the retaining structure, the at least one protrusion seals off any interstice formed between the longitudinal shaft and the surrounding alveolar bone tissue, hence preventing intrusion of bacteria from the oral cavity into any such interstice.

When preparing the root canal prior to implantation of the dental post according to the present invention, the root canal is widened with a drill to provide a bore with defined dimensions, preferably by means of a Trephine-drill. Thereby, the diameter of the drill has to be chosen such that it is from 0.05 mm to 0.1 mm smaller than the diameter of the at least one protrusion. Hence, the diameter of the drill should be from 0.05 mm to 0.1 mm smaller than the sum of the diameter of the longitudinal shaft and twice the second distance. This leads to a primary compression of the alveolar bone tissue around the diameter of the at least one protrusion and allows an immediate sealing effect between the at last one protrusion and the surrounding alveolar bone tissue.

Preferably, the second distance is from 0.05 mm to 0.1 mm larger than the first distance. Selection of the second distance in this range allows for a very efficient sealing between the longitudinal shaft and surrounding alveolar bone tissue by the at least one protrusion.

In a preferred embodiment, the first angle is from 30° to 35°. Selection of the first angle in this range allows for a very efficient dissipation of the forces into the surrounding alveolar bone tissue by the second flank of the at least one protrusion.

Preferably, the at least one protrusion, or the protrusion closest to the second end, in the case that the second portion comprises more than one protrusion, is located next to the second end or at a distance of less than 3 mm from the second end in the direction towards the first end.

This means that the at least one protrusion or the protrusion located closest to the second end is located directly adjacent to the second end or in an area within 3 mm from the second end. Preferably, the transition area of the second flank is located at this distance from the second end, i.e. the cusp of the at least one protrusion is concurrently located slightly further away of the second end in the direction of the first end.

Preferably, the second flank comprises a curved section next to the outer surface in the radial plane including the central axis, said curved section providing a continuous transition from the substantially flat second flank to the outer surface.

The curvature may have any suitable radius. Having a curved section avoids the occurrence of a discontinuous transition between the second flank and the outer surface of the longitudinal shaft, which might have a negative impact on the surrounding alveolar bone as well as to bone ingrowth and which might also lead to destructive peak loads next to the transition area. Preferably, the curved section spans less than 10%, more preferably less than 5% of the length of the second flank in the radial plane including the central axis.

Preferably, the first flank has a constant curvature from the outer surface to the cusp in the radial plane including the central axis. The constant curvature preferably follows an elliptical geometry, i.e. the curvature corresponds to a part of the circumference of an ellipse.

When viewed as a cross section in the radial plane including the central axis, the curvature of the first flank is concave. In other embodiments, however, the first flank may also be substantially flat or have a circular geometry.

Preferably, the cusp has a rounded profile. In a cross-section along the radial plane including the central axis, the cusp preferably has the form of a partial circle, i.e. the cusp has a rounded profile with a constant diameter. Such a profile avoids damages to the surrounding alveolar bone by sharp edges and reduces the occurrence of material breaking off from the cusp. Further, the rounded profile of the cusp has a honing effect when the longitudinal shaft is implanted into a bore of a root canal, which leads to a refinement of the alveolar bone tissue on the surface of the bore, resulting in a better sealing between the at least one protrusion and said alveolar bone tissue.

Preferably, the at least one retaining structure is at least one helical screw thread. The at least one helical screw thread preferably has a pitch of between 1 mm to 1.5 mm, most preferably of 1.25 mm. The at least one screw thread may be right or left-handed.

In an alternatively preferred embodiment, the retaining structure may comprise more than one screw thread, such as two or three screw threads, each of these screw threads having the same pitch and handedness, but having a different start, the start of each of the screw threads being preferably disposed at an angular distance of 360°/n, where n is the number of threads, around the circumference of the longitudinal shaft. In one embodiment, the at least one screw thread may be of the self-cutting type.

In an alternatively preferred embodiment, the at least one retaining structure comprises a plurality of projections. The projections lodge themselves into the surrounding alveolar bone tissue when the longitudinal shaft is inserted into the root canal, hence providing a form-fit connection of the longitudinal shaft with the surrounding alveolar bone tissue.

A plurality of projections is to be understood in that the longitudinal shaft comprises two or more projections. Preferably, however, the longitudinal shaft comprises more than 10, more preferably more than 20 projections distributed on the outer surface of the longitudinal shaft in the first portion.

The projections may have any suitable form. However, preferably, the projections are spherical, pyramidal or in the form of a tetrahedron. Preferably, the protrusions are in the shape of an irregular tetrahedron having one vertex parallel to the central axis and facing towards the first end and having one surface facing substantially towards the second end.

Preferably, the plurality of projections are arranged around the shaft in a helical pattern. This means that all projections are arranged on the outer surface of the longitudinal shaft along a line following the shape of a helix around the outer surface. This allows the insertion of the longitudinal shaft into the root canal with a screwing motion or by pushing the longitudinal shaft into the root canal.

Preferably, the longitudinal shaft comprises at least one flute with a self-tapping edge in the area of the first end. Use of at least one flute with a self-tapping edge allows the longitudinal shaft to tap threads into the surrounding alveolar bone when screwed into the root canal. Preferably, the longitudinal shaft comprises the same number of flutes as the number of screw threads, or in the case that the retaining structure comprises a multitude of protrusions arranged along a helical pattern, as the number of helical patterns thereof.

Preferably, the at least one connection element comprises at least one of: a bore with an inner thread, a shank with an outer thread, a bore with an internal Morse taper or a shank with an outer surface with a Morse taper.

The connection elements serves the purpose to secure an abutment onto the second end of the longitudinal shaft. While longitudinal shaft may only comprise one of the mentioned connection elements, it is also possible that the longitudinal shaft comprises a combination of two or more of said connection elements, such as a shank with an outer Morse taper and a bore with an internal thread. The abutment used in connection with the longitudinal shaft has concurrently matching connection means.

In a preferred embodiment, the at least one connection element comprises a shank with an outer surface with a Morse taper located on the second end of the shaft and extending longitudinally therefrom. The shank comprises at least one circumferential projection extending from an exterior surface of the shank as well as an internal longitudinal perforation. The at least one connection element further comprises an internal bore of the shaft being aligned on the central axis and aligned with the internal longitudinal perforation of the shank, said internal bore comprising a thread.

Once, the dental post is implanted in a root canal, the shank protrudes from the second end outwards of said root canal, wherein the at least one circumferential projection of the shank provides a sealing between the shank and surrounding gingival tissue, thereby reducing the risk of bacterial infiltration between the gingival tissue and the longitudinal shaft.

The second portion preferably comprises at least two protrusions, said at least two protrusions being arranged one next to the other in a direction along the central axis, the second distance of each of said at least two protrusions increasing incrementally in a direction towards the second end. In this embodiment, the protrusion closest to the second end has the largest second distance, while the protrusions further away of the second end have smaller second distances. This arrangement further reduces the occurrence of bacterial intrusion.

Preferably, the second flank of a one protrusion intersects with the first flank of an adjacent protrusion located closer to the second end than said one protrusion in an intersection area of the outer surface, said intersection area having a curved shape in the radial plane including the central axis leading to a continuous transition from the second flank of the one protrusion to the first flank of the adjacent protrusion.

The curved shape in the radial plane including the central axis preferably corresponds to a part of the outer circumference of an ellipse. However, the curved shape may alternatively have another geometry, such as a partial circle, a hyperbole or the like. Preferably, an apex thereof is located on the outer surface of the longitudinal shaft.

The smooth transition has a beneficial effect on bone growth in the region adjacent of the intersection area, as there is no sharp angle.

In a preferred embodiment, the second portion comprises two protrusions, a first of said two protrusions being located closest to the second end having a second distance which is 0.10 mm larger than the first distance, a second of said at least two protrusions being located adjacent to said first protrusion and being located closer to the first end than said first protrusion, and having a second distance which is 0.08 mm larger than said first distance.

Preferably, the second portion additionally comprises a third protrusion, the third protrusion being located adjacent to said second protrusion and being located closer to the first end than said second protrusion, and having a second distance which is 0.05 mm larger than said first distance.

A longitudinal shaft having several protrusions, especially two or three protrusions with an increasing second distance towards the second end allows to provide an even primary compression on the surrounding alveolar bone tissue and further leads to a honing of the bore during implantation of the longitudinal shaft, resulting into a better sealing between the protrusions and the alveolar bone tissue.

Preferably, the longitudinal shaft has a length of from 4 mm to 25 mm, most preferably from 6 mm to 16 mm, especially of 6 mm, 8 mm, 10 mm, 12 mm, 14 mm or 16 mm. The second portion preferably has a length along the central axis from 1 mm to 5 mm.

The shaft preferably has a diameter from 0.8 mm to 5 mm, more preferably from 2 mm to 5 mm and the first distance preferably is from 0.3 mm to 2.0 mm.

If the longitudinal shaft has a cylindrical outer surface, the longitudinal shaft preferably has a diameter from 0.8 mm to 5 mm, most preferably from 1 mm to 2.5 mm, the diameter being constant along the entire length of the longitudinal shaft along the central axis.

If the longitudinal shaft has a conical outer surface, the diameter of the longitudinal shaft increases from the first end towards the second end. Preferably, the diameter increases steadily from the first end to the second end along the central axis. In other preferred embodiments, the increase of the diameter from the first end to the second end may vary along the length of the central axis. The diameter of the longitudinal shaft having a conical outer surface at the first end preferably is between 0.5 to 1.5 mm and the diameter at the second end preferably is from 1 mm to 2.5 mm.

The first distance more preferably is from 0.3 mm to 0.8 mm.

The present application further relates to an embodiment of a dental implant with a longitudinal shaft. The longitudinal shaft comprises a cylindrical outer surface, a central axis, a first end and a second end. At least one connection element is located on the second end. A first portion of the longitudinal shaft extends from the first end towards the second end along a first defined length, the first portion comprising at least one retaining structure to securely anchor the longitudinal shaft in the bore, the at least one retaining structure protruding from the outer surface by a first distance. A second portion of the longitudinal shaft extends from the second end towards the first portion, the second portion comprising at least one circumferential protrusion having a first flank facing towards the first end and extending from the outer surface to a cusp located at a second distance from the outer surface. The second distance is larger than the first distance. The at least one protrusion further includes a second flank facing towards the second end and extending from the cusp to the outer surface. The second flank is substantially flat from the cusp towards the outer surface and is inclined at a first angle of from 20° to 50°, preferably of from 25° to 40° relative to the central axis in a radial plane including the central axis. The dental implant further comprises an abutment connected to the second end of the shaft by means of the at least one connection element. A dental crown is connected to the abutment.

The present application also relates to another embodiment of a dental implant comprising a dental post with a longitudinal shaft. The longitudinal shaft comprises a cylindrical or conical outer surface, a central axis, a first end and a second end. An abutment structure is located on the second end. A first portion of the longitudinal shaft extends from the first end towards the second end along a first defined length, the first portion comprising at least one retaining structure to securely anchor the shaft in the bore, the at least one retaining structure protruding from the outer surface by a first distance. A second portion of the longitudinal shaft extends from the second end towards the first portion. The second portion comprises at least one circumferential protrusion having a first flank facing towards the first end and extending from the outer surface to a cusp located at a second distance from the outer surface. The second distance is larger than the first distance. The at least one protrusion includes a second flank facing towards the second end and extending from the cusp to the outer surface, the second flank being substantially flat from the cusp towards the outer surface and the second flank being inclined at a first angle of from 20° to 50°, preferably of from 25° to 40° relative to the central axis in a radial plane including the central axis. A dental crown is connected to the abutment structure.

The dental implant according to the disclosed embodiments may comprise a dental post with any of the features as described further above. The abutment preferably comprises an outer surface matching the second end of the longitudinal shaft as well as at least one connection feature which may engage the at least one connection element.

The dental crown may either be a removable dental crown which is detachably connected to the abutment or abutment structure by means as known in the art, e.g. by a form fit connection or the like, or a fixed dental crown which is permanently screwed or glued to the abutment or abutment structure. The dental crown comprises a partial or full denture. If the dental crown is of the fixed type, the dental crown may be shaped to replace several neighbouring teeth.

Other advantageous embodiments and combinations of features come out from the detailed description below and the entirety of the claims.

### BRIEF DESCRIPTION OF THE SEVERAL VIEWS OF THE DRAWINGS

Further advantages features and details of the various embodiments of this disclosure will become apparent from the ensuing description of a preferred exemplary embodiment or embodiments and further with the aid of the drawings. The features and combinations of features recited below in the description, as well as the features and feature combination shown after that in the drawing description or in the drawings alone, may be used not only in the particular combination recited but also in other combinations on their own without departing from the scope of the disclosure.

The following is an advantageous embodiment of the invention with reference to the accompanying figures, wherein:

FIG. 1 depicts an embodiment of an inventive dental implant with a dental post according to the present invention implanted in a root canal in a three-dimensional representation with a partial cut-view;

FIG. 2 depicts a detailed view of the area of the second end of the dental implant and dental post according to FIG. 1, wherein one half of the dental implant and dental post is shown as a cut-view along a radial plane including the central axis;

FIG. 3 depicts a longitudinal section of a part of the dental implant and of the dental post according to FIGS. 1 and 2 showing details of the protrusions;

FIG. 4 depicts examples of forces acting on a dental crown due to the masticating process; and

FIG. 5 depicts a further embodiment of a dental post according to the present invention with an abutment connected to the second end of the longitudinal shaft, the first portion comprising a retaining structure including a plurality of projections.

In the figures, the same components are given the same reference symbols.

### DETAILED DESCRIPTION OF THE INVENTION

As used throughout the present disclosure, unless specifically stated otherwise, the term “or” encompasses all possible combinations, except where infeasible. For example, the expression “A or B” shall mean A alone, B alone, or A and B together. If it is stated that a component includes “A, B, or C”, then, unless specifically stated otherwise or infeasible, the component may include A, or B, or C, or A and B, or A and C, or B and C, or A and B and C. Expressions such as “at least one of” do not necessarily modify an entirety of the following list and do not necessarily modify each member of the list, such that “at least one of “A, B, and C” should be understood as including not only one of A, only one of B, only one of C, or any combination of A, B, and C.

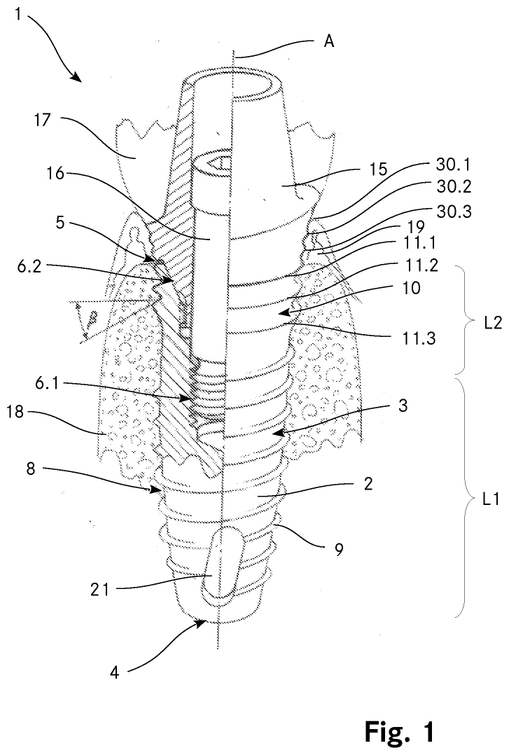

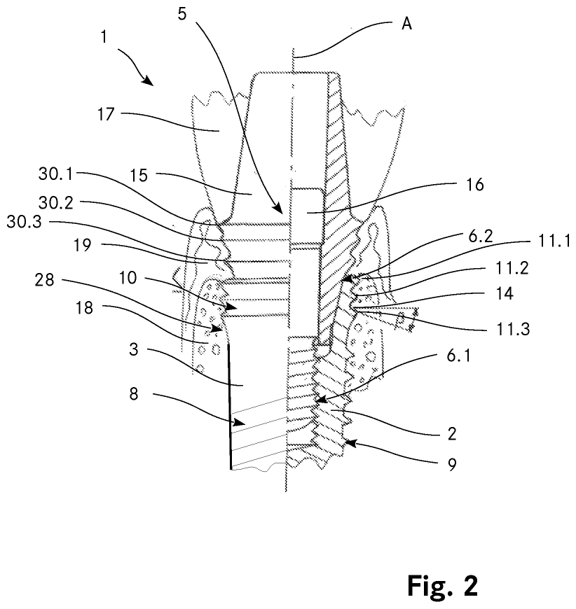

FIG. 1 shows an embodiment of a dental implant 1 with a dental post 28 according to the present invention implanted in a root canal in a three-dimensional representation with a partial cut-view. FIG. 2 shows a detailed view of the area of the second end 5 of the dental implant 1 and dental post 28 according to FIG. 1, wherein one half of the dental implant 1 and dental post 28 is shown as a cut-view along a radial plane including the central axis A.

The dental implant 1 comprises a dental post 28 with a longitudinal shaft 2 including a first end 4, a second end 5, a conical outer surface 3 and a central axis A. The longitudinal shaft 2 includes a first portion 8 extending from the first end 4 towards the second end 5 along a first defined length L1 as well as a second portion 10 extending from the second end 5 towards the first portion 8 along a second defined length L2. In the embodiment shown, the longitudinal shaft 2 only comprises the first portion 8 and the second portion 10, however, in other embodiments, the longitudinal shaft 2 may comprises additional portions.

At the second end 5, the longitudinal shaft 2 comprises two connection elements 6.1, 6.2, a first connection element 6.1 being in the form of an internal bore concentric with the central axis A and having an internal thread, as well as a second connection element 6.2 in the form of a bore with an internal Morse taper. An abutment 15 is connected to the second end 5 of the longitudinal shaft 2 by means of a screw 16 being in engagement with the internal thread of the first connection element 6.1. The abutment 15 further comprises an outer surface in the form of a Morse taper which matches the surface of the bore with the internal Morse taper of the second connection element 6.2. As shown, a dental crown is attached to the abutment 15. The abutment 15 further comprises three circumferential projections 30.1, 30.2, 30.3 which protrude from an outer surface of the abutment 15 and which provide a sealing effect with gingival tissue 19 surrounding the abutment 15.

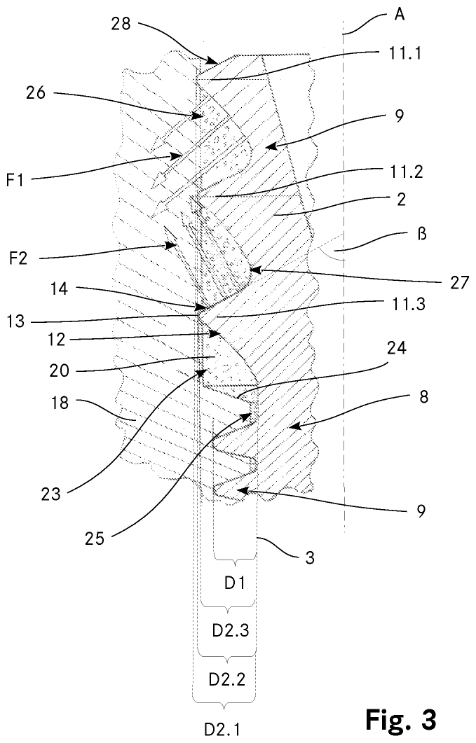

The first portion 8 comprises a retaining structure 9 which protrudes from the outer surface 3 by a first distance D1 (see FIG. 3) and which is configured as a single screw thread in the embodiment shown. The longitudinal shaft 2 is securely anchored in surrounding alveolar bone tissue 18 by means of the retaining structure 9. Further, in the area of the first end 4, the longitudinal shaft 2 comprises a flute 21 with a self-tapping edge. This flute allows the longitudinal shaft 2 to cut a thread matching the screw thread of the retaining structure 9 into the alveolar bone tissue 18 when the longitudinal shaft 2 is screwed into the root canal.

As may be seen of FIG. 1 the longitudinal shaft 2 is entirely surrounded by the alveolar bone tissue 18, while the abutment 15 partially protrudes from the alveolar bone tissue 18 and is at least in part surrounded by gingival tissue and protruding into the oral cavity. The dental crown is almost completely arranged in the oral cavity with the exception of a small part thereof being surrounded by the gingival tissue 19.

The second portion 10 of the longitudinal shaft comprises three circumferential protrusions 11.1, 11.2, 11.3 arranged one next to another along the central axis A and protruding from the outer surface 8. Each of the three circumferential protrusions 11.1. 11.2, 11.3 comprises a first flank 12 facing the first end 4 and extending from the outer surface to a cusp 13 (see FIG. 3). Each of the three circumferential protrusions 11.1, 11.2, 11.3 further comprise a second flank 14 facing the second end 5 and extending from the cusp 13 towards the outer surface 3 (see FIG. 3). The second flanks 15 are substantially flat and arranged at a first angle β relative to the central axis A in a radial plane including the central axis A. It is to be noted that the cut-away part of FIG. 1 is cut along such a radial plane including the central axis A. The three protrusions 11.1, 11.2, 11.3 protrude from the outer surface 3 by a second distance D2 which is larger than the first distance D1 (see FIG. 3).

FIG. 3 shows a longitudinal section of a part of the dental implant 1 and of the dental post 28 according to FIGS. 1 and 2 showing details of the protrusions 11.1, 11.2, 11.3. It is to be noted that the cutting plane on FIG. 3 is a radial plane including the central axis A.

The retaining structure 9 is configured as a single screw thread having a substantially triangular cross-section with a pitch P. The retaining structure 9, i.e. the screw thread protrudes from the outer surface 3 of the longitudinal shaft 2 by the first distance D1.

The protrusions 11.1, 11.2, 11.3 protrude from the outer surface 3 each by a second distance D2.1, D2.2, D2.3, which are each larger than the first distance D1. In the embodiment as shown, each protrusion 11.1, 11.2, 11.3 protrudes by a different second distance D2.1, D2.2, D2.3 from the outer surface 8 of the longitudinal shaft 2. The protrusion 11.3 located closest to the first end 4 has the smallest second distance D2.3. The second distances D2.1, D2.2 of the protrusions increase in a step-wise manner towards the second end 5, so that the protrusion D2.1 closest to the second end 5 has the largest second distance D2.1 of the protrusions 11.1, 11.2, 11.3. For example, the protrusion 11.3 closest to the first end 4 may have a second distance D2.3 which is 0.05 to 10 mm larger than the first distance D1, the next protrusion 11.2 in the direction of the second end 5 may have a second distance D2.2 which is 0.08 mm larger than the first distance D1, and the protrusion 11.1 located closest to the second end 5 may have a second distance D2.1 which is 0.10 mm larger than the first distance D1. This stepwise increase of the second distances D2.1, D2.2, D2.3 in the direction of the second end 5 allows an even distribution of the primary compression exerted by the protrusions 11.1, 11.2, 11.3 onto the surrounding alveolar bone tissue 18 and also has a beneficial honing effect on the wall of the bore 23 which leads to a better sealing effect between the protrusions 11.1, 11.2, 11.3 and the surrounding alveolar bone tissue 18.

Each of the protrusions 11.1, 11.2, 11.3 comprise a first flank 12 facing towards the first end 4 and extending from the outer surface 3 to the cusp 13. As may be readily seen on FIG. 3, the first flank 12 has the shape of a part of an ellipse along the radial plane including the central axis A (which is concurrent with the cutting plane in FIG. 3). The cusp 13 has a circular cross-section in said plane. The second flank 14 faces towards the second end 5 of the longitudinal shaft 2 and is substantially flat, i.e. the second flank 14 has the form of a substantially straight line in the radial plane including the central axis A. The second flank 14 is inclined relative to the central axis A by a first angle β of from 20° to 50°, preferably of from 25° to 40° in the radial plane including the central axis A and ascends from the cusp 13 towards the outer surface 3 in the direction of the second end. Contrary thereto the first flank 12 descends from the cusp 12 towards the outer surface 3 in the direction of the first end 4.

An intersection area 27 is located between adjacent protrusions 11.1, 11.2, 11.3. The intersection area 27 provides a smooth transition between the second flank 14 of a protrusion 11.1, 11.2 and the first flank 12 of a neighboring protrusion 11.2, 11.3. The intersection area 27 has a cross-section in the form of a partial ellipse as seen along the radial plane including the central axis A with an apex located on the outer surface 3 of the longitudinal shaft 2.

The longitudinal shaft 2 of the dental post 28 is implanted into a bore 23 which is located in a root canal of a tooth. As may be seen in FIG. 3, the bore 23 comprises a step 24 and hence includes two parts 25, 26 having different diameters, whereby a lower part 25 of the bore 23 has a smaller diameter compared to an upper part 26 thereof. Such bores 23 may be made by using appropriate drills, especially by means of Trephine drills. It is to be noted that the diameters of the drills used to drill the bore 23 are chosen such as to match the diameter and form of the longitudinal shaft 2. The diameter of both parts 25, 26 is especially chosen such that the retaining structure 9 and the protrusions 11.1, 11.2, 11.3 may engage with or into the surrounding alveolar bone tissue 18. Interstices 20 between the longitudinal shaft 2 and the surrounding alveolar bone tissue 18 remain void after the implantation of the longitudinal shaft 2. However, after a few weeks, alveolar bone tissue will grow into the interstices 20, as shown in FIG. 3.

The protrusions 11.1, 11.2, 11.3 prevent bacterial infiltration into the interstices 20 by providing a sealing effect between the longitudinal shaft 2 and the surrounding alveolar bone tissue 18. Further, the protrusions 11.1, 11.2, 11.3 dissipate forces acting parallel to the central axis A onto the longitudinal shaft 2 by means of their first flanks 12 and their second flanks 14 evenly into the surrounding alveolar bone tissue 18, as exemplarily shown by the arrows F1 and F2.

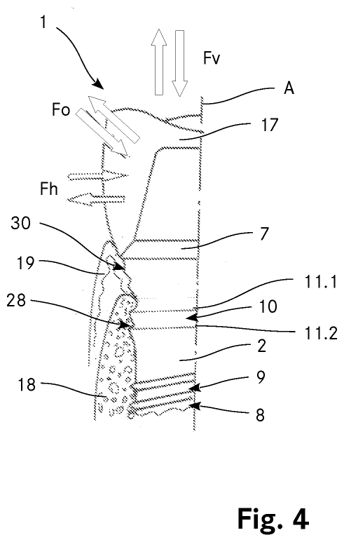

The forces acting on the longitudinal shaft 2 arise during mastication and are being transferred from the dental crown onto the abutment 15 or abutment structure 7 and finally to the longitudinal shaft 2 (see FIG. 4). While forces parallel to the central axis A and directed towards the first end 4 of the longitudinal shaft 2 may be dissipated through the first end 4 to the alveolar bone tissue 18 as well, forces directed towards the second end 30 5, as typically arising during unloading in the masticatory process, will only be dissipated through the retaining structure 9 in dental posts as known in the art. This leads to great stresses in the alveolar bone tissue 18 located next to the retaining structure 9. These stresses may lead to a detachment of the longitudinal shaft 2 from the surrounding alveolar bone tissue 18 and have been identified as main cause for peri-implantitis and peri-implant mucositis. By comprising a second flank 14 at an angle of from 20° to 50°, preferably of from 25° to 40° relative to the central axis A, the protrusions 11.1, 11.2, 11.3 of a dental post 28 or dental implant 1 according to the present invention dissipate said forces in an oblique direction which away of the central axis A and in the direction of the second end 5 into the surrounding alveolar bone tissue 18. This allows to evenly distribute these forces into the surrounding alveolar bone tissue 18 thereby greatly reducing the stress and avoiding any peak stresses in certain areas, which may lead to a detachment between the longitudinal shaft 2 and the surrounding alveolar bone tissue 18. Further, this force dissipation also avoids any residual stress in the alveolar bone tissue 18 surrounding the longitudinal shaft 2. This mitigates the occurrence of peri-implantitis and peri-implant mucositis.

FIG. 4 exemplarily shows the forces acting on a dental crown 17 due to the masticating process. The embodiment of the dental implant 1 shown in this figure comprises a dental post 28 with a longitudinal shaft 2 having an abutment structure 7 located on its second end 5 instead of an abutment 15 attached to the second end 5 as shown in the embodiments according to FIGS. 1 to 3. The abutment structure 7 also comprises circumferential projections 30 similar to the abutment structure 7 as shown in FIGS. 1 to 3. The forces are transmitted from the dental crown 17 to the abutment structure 7 and further on to the longitudinal shaft 2.

In essence, there are three forces Fv, Fo, Fh acting on the dental crown 17. A first of these forces is a vertical force Fv which acts parallel to the central axis A and in the direction of the first end 4 of the longitudinal shaft 2. It is noted that during unloading in the masticating process, the vertical force Fv will act in the direction of the second end 5. A second force is a horizontal force Fh which acts in a direction orthogonal to the central axis A. A third force is an oblique force Fo which acts in a direction which is angled relative to the central axis A.

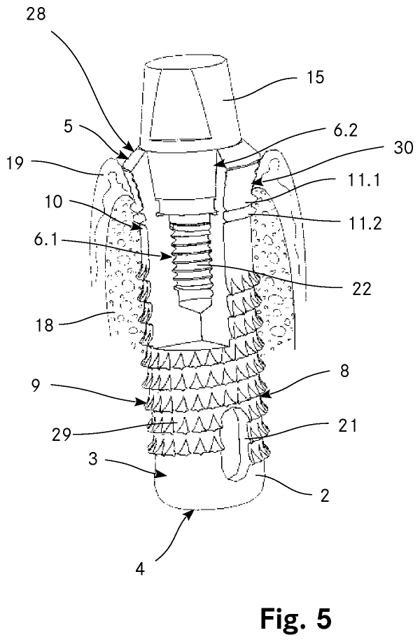

FIG. 5 shows a further embodiment of a dental post 28 with an abutment 15 connected to the second end 5 of the longitudinal shaft 2. This embodiment of the dental post 28 differs from the embodiments as shown in FIGS. 1 to 4 in that the retaining structure 9 comprises a plurality of projections 29 which are arranged one next to each other around the longitudinal shaft 5 in a helical pattern, i.e. following a helical line. In the embodiment shown, each of the projections have the shape of a tetrahedron with one vertex being parallel to the central axis A and facing towards the first end 4. One face of the tetrahedron faces generally towards the second end 5. Provision of a retaining structure 9 with a plurality of projections arranged in a helical pattern around the longitudinal shaft 5 allows inserting the longitudinal shaft 5 into a bore 28 in a root canal by a screwing motion or by pushing the longitudinal shaft 5 vertically downwards. The longitudinal shaft 2 according to this embodiment also comprises one flute 21 with a cutting edge in order to facilitate the insertion of the longitudinal shaft 2 by a screwing motion, as the flute 21 cuts a thread into the alveolar bone tissue 18. With the exception of the configuration of the retaining structure 9, the longitudinal shaft according to this embodiment comprises the features according to the embodiments of FIGS. 1 to 3.

The scope of protection of the present invention is given by the claims and is not limited by the features illustrated in the description or shown in the figures.

What is claimed is:

1. A dental post comprising a longitudinal shaft to be inserted into a bore in a root canal, the longitudinal shaft comprising:
a) a cylindrical or conical outer surface,
b) a central axis,
c) a first end,
d) a second end,
e) at least one connection element located on the second end or an abutment structure located on the second end,
f) a first portion extending from the first end towards the second end along a first defined length, the first portion comprising at least one retaining structure to securely anchor the shaft in the bore, the at least one retaining structure protruding from the outer surface by a first distance, and
g) a second portion extending from the second end towards the first portion, the second portion comprising at least one circumferential protrusion having a first flank facing towards the first end and extending from the outer surface to a cusp located at a second distance from the outer surface, the second distance being larger than the first distance, the at least one protrusion including a second flank facing towards the second end and extending from the cusp to the outer surface, and the second flank being substantially flat from the cusp towards the outer surface,
wherein the second flank is inclined at a first angle of from 20° to 50° relative to the central axis in a radial plane including the central axis.

2. The dental post according to claim 1, wherein the second distance is from 0.05 mm to 0.1 mm larger than the first distance.

3. The dental post according to claim 1, wherein the first angle is from 30° to 35°.

4. The dental post according to claim 1, wherein the at least one protrusion or the protrusion closest to the second end, when the second portion comprises more than one protrusion, is arranged next to the second end or at a distance of less than 3 mm from the second end in the direction towards the first end.

5. The dental post according to claim 1, wherein the second flank comprises a curved section next to the outer surface in the radial plane including the central axis, said curved section providing a continuous transition from the substantially flat second flank to the outer surface.

6. The dental post according to claim 1, wherein the first flank has a constant curvature from the outer surface to the cusp in the radial plane including the central axis.

7. The dental post according to claim 1, wherein the cusp has a rounded profile and a cross-section along the radial plane including the central axis.

8. The dental post according to claim 1, wherein the at least one retaining structure is at least one helical screw thread.

9. The dental post according to claim 1, wherein the at least one retaining structure comprises a plurality of projections.

10. The dental post according to claim 9, wherein the plurality of projections are arranged around the shaft in a helical pattern.

11. The dental post according to claim 1, wherein the shaft comprises at least one flute with a self-tapping edge in the area of the first end.

12. The dental post according to claim 1, wherein the at least one connection element comprises at least one of a bore with an inner thread, a shank with an outer thread, a bore with an internal Morse taper or a shank with an outer surface with a Morse taper.

13. The dental post according to claim 12, wherein the at least one connection element comprises a shank with an outer surface with a Morse taper located on the second end of the shaft and extending longitudinally therefrom, the shank comprising at least one circumferential projection extending from an exterior surface of the shank as well as an internal longitudinal perforation, the at least one connection element further comprising an internal bore of the shaft being aligned on the central axis and aligned with the internal longitudinal perforation of the shank, said internal bore comprising a thread.

14. The dental post according to claim 1, wherein the second portion comprises at least two protrusions, said at least two protrusions being arranged one next to the other in a direction along the central axis, the second distance of each of said at least two protrusions increasing incrementally in a direction towards the second end.

15. The dental post according to claim 14, wherein the second flank of a one protrusion intersects with the first flank of an adjacent protrusion located closer to the second end than said one protrusion in an intersection area of the outer surface, said intersection area having a curved shape in the radial plane including the central axis leading to a continuous transition from the second flank of the one protrusion to the first flank of the adjacent protrusion.

16. The dental post according to claim 14, wherein the second portion comprises two protrusions, a first of said two protrusions being located closest to the second end having a second distance which is 0.10 mm larger than the first distance, a second of said at least two protrusions being located adjacent to said first protrusion and being located closer to the first end than said first protrusion, and having a second distance which is 0.08 mm larger than said first distance.

17. The dental post according to claim 16, wherein the second portion additionally comprises a third protrusion, the third protrusion being located adjacent to said second protrusion and being located closer to the first end than said second protrusion, and having a second distance which is 0.05 mm larger than said first distance.

18. The dental post according to claim 1, wherein the shaft has a length along the central axis from 4 mm to 25 mm and wherein the second portion has a length along the central axis from 1 mm to 5 mm.

19. The dental post according to claim 1, wherein the shaft has a diameter from 0.8 mm to 5 mm and the first distance is from 0.3 mm to 2.0 mm.

20. A dental implant comprising a dental post with a longitudinal shaft, the shaft comprising:
a) a cylindrical or conical outer surface,
b) a central axis,
c) a first end,
d) a second end,
e) at least one connection element located on the second end,
f) a first portion extending from the first end towards the second end along a first defined length, the first portion comprising at least one retaining structure to securely anchor the shaft in the bore, the at least one retaining structure protruding from the outer surface by a first distance,
g) a second portion extending from the second end towards the first portion, the second portion comprising at least one circumferential protrusion having a first flank facing towards the first end and extending from the outer surface to a cusp located at a second distance from the outer surface, the second distance being larger than the first distance, the at least one protrusion including a second flank facing towards the second end and extending from the cusp to the outer surface, and the second flank being substantially flat from the cusp towards the outer surface and the second flank being inclined at a first angle of from 20° to 50° relative to the central axis in a radial plane including the central axis; and
wherein an abutment is connected to the second end of the shaft by means of the at least one connection element and wherein a dental crown is connected to the abutment.

21. A dental implant comprising a dental post with a longitudinal shaft, the longitudinal shaft comprising:
a) a cylindrical or conical outer surface,
b) a central axis,
c) a first end,
d) a second end,
e) an abutment structure located on the second end,
f) a first portion extending from the first end towards the second end along a first defined length, the first portion comprising at least one retaining structure to securely anchor the shaft in the bore, the at least one retaining structure protruding from the outer surface by a first distance,
g) a second portion extending from the second end towards the first portion, the second portion comprising at least one circumferential protrusion having a first flank facing towards the first end and extending from the outer surface to a cusp located at a second distance from the outer surface, the second distance being larger than the first distance, the at least one protrusion including a second flank facing towards the second end and extending from the cusp to the outer surface, the second flank being substantially flat from the cusp towards the outer surface and the second flank being inclined at a first angle of from 20° to 50° relative to the central axis in a radial plane including the central axis; and
wherein a dental crown is connected to the abutment structure.
